(19) United States
(12) Patent Application Publication
(10) Pub. No.: US 2026/0205315 A1
(43) Pub. Date: Jul. 16, 2026

(54) Identity-Continuity Authentication State Machine with Privacy Proof, Recoverable Authorization, and Clawback-Enabled High-Value Operation Approval

(71) Applicant: Furong BEI, San Gabriel, CA (US)

(72) Inventor: Furong BEI, San Gabriel, CA (US)

(21) Appl. No.: 19/445,557

(22) Filed: Jan. 11, 2026

Related U.S. Application Data
(63) Continuation-in-part of application No. 19/056,745, filed on Feb. 19, 2025.
(63) Continuation-in-part of application No. 19/192,322, filed on Apr. 28, 2025.
(63) Continuation-in-part of application No. 19/196,039, filed on May 1, 2025.
(63) Continuation-in-part of application No. 19/074,326, filed on Mar. 8, 2025, now abandoned.
(63) Continuation-in-part of application No. 19/079,378, filed on Mar. 13, 2025.
(63) Continuation-in-part of application No. 19/078,276, filed on Mar. 13, 2025.
(63) Continuation-in-part of application No. 19/080,825, filed on Mar. 15, 2025.
(63) Continuation-in-part of application No. 19/083,396, filed on Mar. 18, 2025.
(63) Continuation-in-part of application No. 19/084,806, filed on Mar. 20, 2025.
(63) Continuation-in-part of application No. 19/094,730, filed on Mar. 28, 2025.
(63) Continuation-in-part of application No. 19/315,561, filed on Aug. 31, 2025.
(60) Provisional application No. 63/769,143, filed on Mar. 9, 2025.
(60) Provisional application No. 63/772,633, filed on Mar. 16, 2025.

(51) Int. Cl. H04L 9/32

(52) U.S. Cl. CPC H04L 9/3271; H04L 9/3218

(57) ABSTRACT

An identity-continuity authentication state machine and recoverable authorization system are disclosed. A policy engine selects an authentication path using fused risk and consistency signals, and verifies a device proof generated by a hardware-protected device key within a secure execution environment. A BEISIGN privacy proof assertion provides minimal disclosure of control, eligibility, or authorization conditions. Upon success, the system issues a session token or an operation authorization token and writes auditable cryptographic summaries. When key-state drift or binding inconsistency is detected, the state machine transitions into recovery mode and executes a closed loop including bounded rollback (BEI-ROLLBACK/BEIFR2) to a prior consistent checkpoint, mandatory epoch rotation, revocation/clawback of prior tokens and bindings, and BEI-CALLBACK threshold adjudication for controlled re-binding. Optional embodiments integrate ID document chip challenge-response, physical marking verification, and time-hierarchy binding (HOUR/DAY/WEEK/YEAR).

### CROSS-REFERENCE TO RELATED APPLICATIONS

This application is a continuation-in-part of the U.S. application Ser. No. 19/056,745, filed Feb. 19, 2025, the entire disclosure of which is incorporated herein by reference.

To the extent applicable, this application further claims the benefit of domestic priority under 35 U.S.C. § 120 to any copending parent application(s) in the same continuation, divisional, or continuation-in-part chain as the foregoing application, as properly identified in the Application Data Sheet (ADS). In the event of any inconsistency between this specification and the ADS regarding a claim for domestic benefit, the ADS shall control.

In addition, the following U.S. applications are incorporated herein by reference for technical background and ecosystem context, to the extent not inconsistent with the present disclosure: U.S. application Ser. No. 19/059,110, filed Feb. 20, 2025; U.S. application Ser. No. 19/060,663, filed Feb. 22, 2025; U.S. application Ser. No. 19/067,732, filed Feb. 28, 2025; U.S. application Ser. No. 19/072,075, filed Mar. 6, 2025; U.S. application Ser. No. 19/073,574, filed Mar. 7, 2025; U.S. application Ser. No. 19/074,326, filed Mar. 8, 2025; U.S. application Ser. No. 19/084,790, filed Mar. 20, 2025; U.S. application Ser. No. 19/086,144, filed Mar. 21, 2025; U.S. application Ser. No. 19/094,730, filed Mar. 28, 2025; and U.S. application Ser. No. 19/374,710, filed Oct. 30, 2025.

### FIELD OF THE INVENTION

The invention relates to information security, identity authentication, access control, cryptographic proofs, privacy-preserving attestations, recoverable authorization, and dispute-capable revocation. More specifically, the invention relates to an identity-continuity authentication state machine that provides low-friction authentication for legitimate subjects and an engineered, auditable recovery closed loop when key state drift or binding inconsistency occurs, and that extends the same trust decision into high-value operation authorization and clawback across domains.

### BACKGROUND OF THE INVENTION

Many authentication systems rely on passwords, multi-factor authentication (MFA), push confirmations, one-time codes, and sensory CAPTCHA challenges (visual characters difficult to read or audio prompts difficult to hear). In real-world deployments, such approaches often exhibit systemic failures.

First, usability failure and false rejection loops are common. Sensory CAPTCHA and repeated MFA challenges may disproportionately block legitimate users. Repeated failures can trigger stricter risk controls, creating a loop in which legitimate users are repeatedly rejected.

Second, key state drift or binding mismatch occurs frequently. Device replacement, authenticator reinstallation, migration failure, secure enclave resets, policy changes, or broken callback contexts can cause a mismatch between server-side binding state and the subject's available device key state, preventing successful authentication.

Third, there is a lack of an engineered recovery closed loop. Many systems provide only repeated attempts or a single-point customer support flow, lacking auditable, revocable, rollback-capable, threshold-adjudicated recovery procedures.

Fourth, fragmented semantics often exist between login and high-value operations. Login authentication and high-value actions (resource access, transfers, exchange, clearing approval, privileged administrative changes) are often handled inconsistently, reducing security and auditability and complicating revocation and dispute handling.

Accordingly, there is a need for an authentication architecture that reduces false rejection, avoids repetitive failure loops, preserves privacy via minimal disclosure, and provides an engineered, auditable recovery closed loop for key state drift events while supporting cross-domain high-value authorization, clawback, and dispute evidence.

### SUMMARY OF THE INVENTION

The invention provides an identity-continuity authentication state machine that selects an authentication path based on fused risk signals and consistency signals and verifies a device proof plus a BEISIGN privacy proof assertion to issue a session token or an operation authorization token.

The invention further provides a recoverable authorization closed loop that detects key state drift and transitions into recovery mode, performing bounded rollback (BEI-ROLLBACK/BEIFR2), revocation and clawback (CALLBACK/CLAWBACK), and threshold adjudication (BEI-CALLBACK) to re-bind new keys or devices and restore legitimate control.

Optional integration is provided with identification document chip challenge-response, physically unclonable physical markings, and AOA/DEA/WICA multi-signal fusion to improve security and reduce user friction, including in cross-industry authorization, clearing approvals, and automated terminal self-service recovery.

Key advantages include reducing false rejection and repetitive failure loops by using a policy-driven state machine that escalates or enters recovery automatically rather than forcing endless retries. The system treats key state drift as a governable technical condition with auditable rollback, revocation, and adjudicated re-binding. It supports privacy-preserving minimal disclosure (BEISIGN, optionally SIGN-SIGNED chain verification) and extends authentication decisions into operation authorization tokens with unified clawback and audit indices.

### BRIEF DESCRIPTION OF THE DRAWINGS

The accompanying drawings are schematic and not necessarily to scale. Reference numerals refer to elements described herein.

FIG. 1 is a block diagram of an example identity-continuity authentication and recovery system (100) including a terminal device (110), a secure execution environment (112), a policy engine (130), a challenge service (132), a BEISIGN proof service (134), a verifier (136), a rollback controller (140), an adjudication node set (150), and an audit record module (160), optionally including an ID document interface (170) and a physical marking capture module (180).

FIG. 2 is a flow diagram of an example identity-continuity authentication process (200) for generating and verifying a device proof and a BEISIGN privacy proof assertion and issuing a session token or operation authorization token.

FIG. 3 is a state diagram of an example identity-continuity authentication state machine (300) including normal authentication (310), stepped-up authentication (320), denial and hold (330), drift detection (340), recovery mode (350), re-binding and epoch rotation (360), and completion (370).

FIG. 4 is a flow diagram of an example recoverable authorization process (400) including detection of key state drift, selecting a recovery path, bounded rollback (BEI-ROLLBACK/BEIFR2), revocation and clawback (CALLBACK/CLAWBACK), threshold adjudication (BEI-CALLBACK), and re-binding.

FIG. 5 is a data structure diagram of an example token format (500) including a session token (510) and an operation authorization token (520), each including scope (522), object identifiers (524), validity constraints (526), revocation identifiers (528), and audit indices (530).

FIG. 6 is a data structure diagram of an example audit record format (600) including time indices (610), revocation indices (620), adjudication indices (630), and context indices (640), optionally storing only cryptographic summaries.

FIG. 7 is a flow diagram of an example document-based authentication process (700) using an ID document chip challenge-response (710) and/or a physically unclonable physical marking verification (720) combined with device proof and BEISIGN proof.

FIG. 8 is a flow diagram of an example cross-industry high-value authorization and clearing approval process (800) using an operation authorization token with unified clawback and auditability.

FIG. 9 is a flow diagram of an example automated terminal self-service recovery process (900), such as at an automated teller machine (ATM), using BEI-CALLBACK threshold adjudication and bounded rollback with clawback and epoch rotation.

### DETAILED DESCRIPTION OF THE INVENTION

### Definitions and Terms

For clarity, the following terms are used. “Identity-continuity authentication state machine” refers to a policy-driven state machine that selects among authentication paths and transitions into a recovery closed loop when drift or inconsistency is detected. “Key state drift” refers to a condition in which server-side binding state (for example, registered device key, authenticator binding, callback context, or policy epoch) is inconsistent with the subject's currently available device key state and or the request context, preventing successful completion of authentication.

“Device proof” refers to a cryptographic signature or attestation generated using a device key protected by a secure execution environment (112) (for example, TPM, secure enclave, secure element, trusted execution environment, or equivalent). “BEISIGN privacy proof assertion” refers to a privacy-preserving minimal-disclosure assertion that proves the subject satisfies control, eligibility, or authorization conditions without disclosing unnecessary raw identity data. “SIGN-SIGNED” refers to an optional chained verification structure in which a proof or assertion is signed by another signature, enabling cross-domain verifiability.

“BEI-CALLBACK” refers to a threshold adjudication mechanism using m-of-n threshold signatures and or weighted threshold signatures across multiple node types. “CALLBACK” and “CLAWBACK” refer to revocation mechanisms for invalidating prior tokens and bindings; clawback renders previously issued tokens unusable for access or high-value approvals. “BEI-ROLLBACK” and “BEIFR2” refer to a bounded rollback mechanism that reverts to a prior consistent checkpoint within defined constraints and triggers epoch rotation to prevent replay and to enforce freshness boundaries.

“AOA”, “DEA”, and “WICA” refer to optional modules for presence and near-field consistency (AOA) and multi-signal fusion and parameter adaptation (DEA and WICA) to determine confidence, thresholds, rollback windows, and escalation decisions. “Operation authorization token” refers to a token authorizing a high-value operation such as resource access control, asset transfer, exchange, clearing approval, contract signing, or privileged administrative changes. As used herein, “high-value authorization” includes authorization for at least one of transfer, exchange, clearing approval, contract signing, privileged administrative change, or any other operation having a policy-defined value threshold, and is distinct from ordinary session access authorization.

### System Architecture

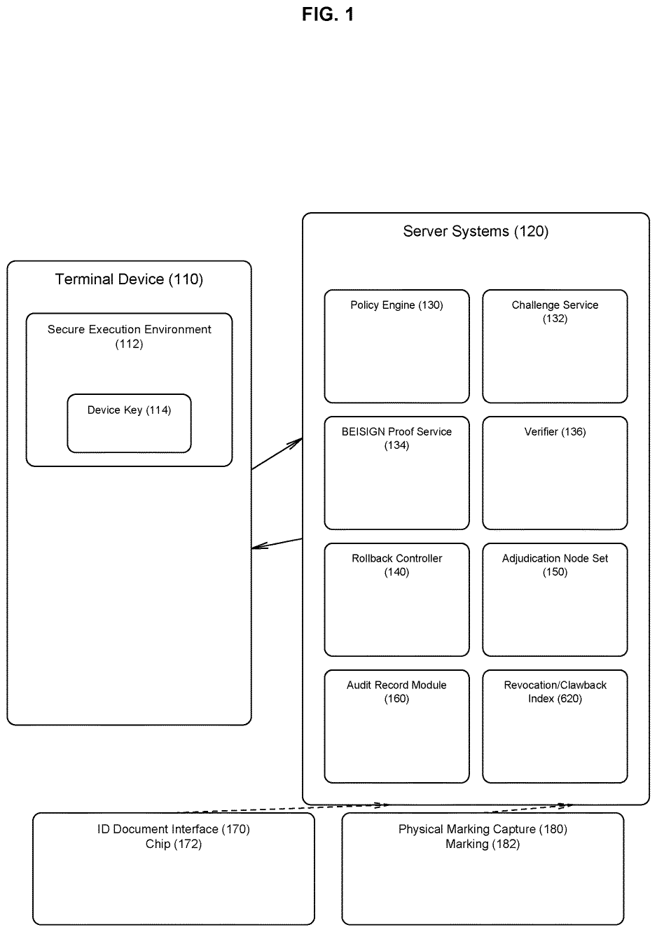

FIG. 1 illustrates system (100). A terminal device (110) (for example, smartphone, workstation, kiosk, dedicated terminal, or embedded device) includes a secure execution environment (112) storing a device key (114). The terminal device (110) communicates with server systems (120).

Server systems (120) include a policy engine (130) that evaluates risk signals and or consistency signals to select an authentication level and an authentication path. A challenge service (132) generates cryptographic challenges. A BEISIGN proof service (134) constructs BEISIGN privacy proof assertions. A verifier (136) verifies device proofs and BEISIGN assertions.

For drift and recovery, a rollback controller (140) performs BEI-ROLLBACK and BEIFR2 bounded rollback and triggers epoch rotation. An adjudication node set (150) performs BEI-CALLBACK threshold adjudication. An audit record module (160) stores cryptographic summaries and indices. Optionally, the system includes an ID document interface (170) for reading an ID document chip (172) and performing chip challenge-response, and a physical marking capture module (180) for capturing a physically unclonable marking (182) and producing a physical fingerprint summary.

### Identity-Continuity Authentication Process

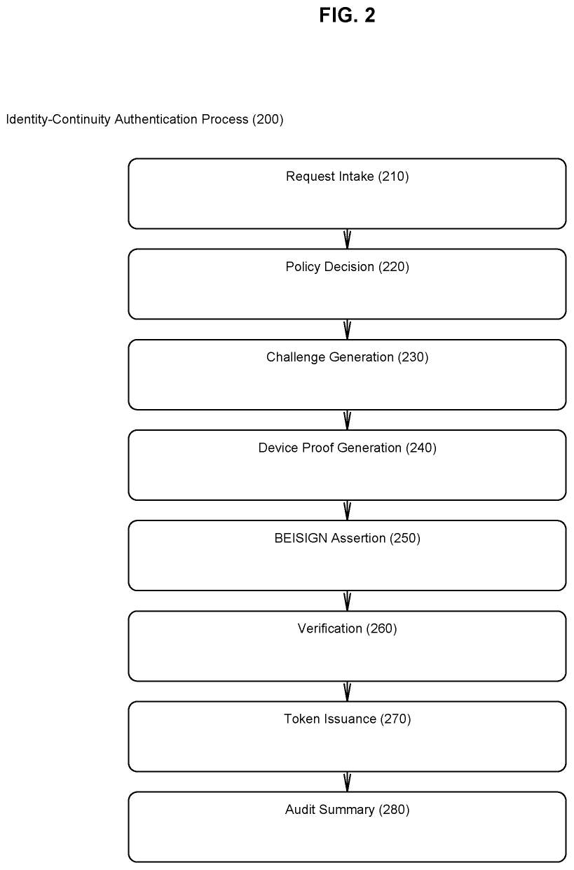

FIG. 2 illustrates process (200). In Step 210 (Request Intake), server systems (120) receive a request associated with a subject identifier, scenario context, and request type (access or operation). In Step 220 (Policy Decision), policy engine (130) determines an authentication level and selects an authentication path.

### Risk and Consistency Signal Set, Fusion, and Authentication-Level Selection

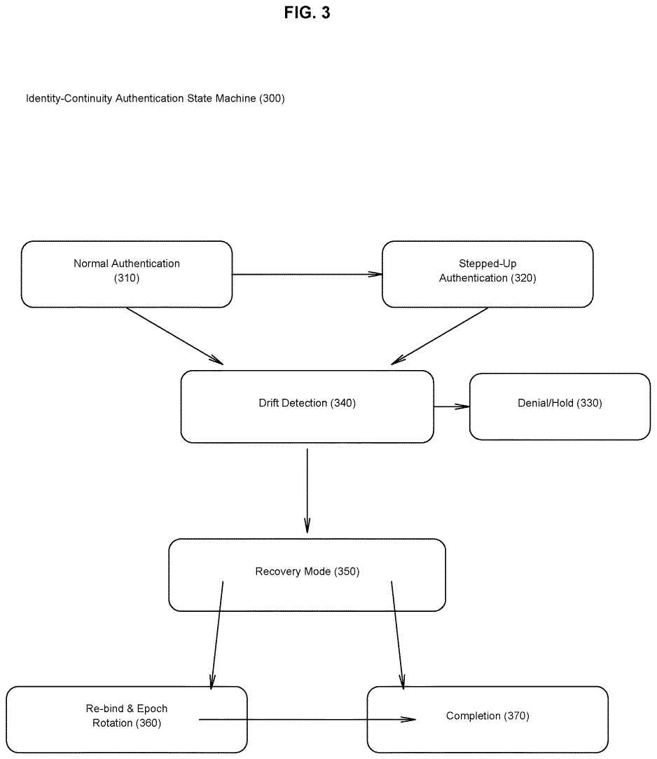

In some embodiments, policy engine (130) determines the authentication level and selects an authentication path using a risk and consistency signal set and a fusion rule, optionally employing AOA, DEA, and WICA logic (FIG. 2 Step 220; FIG. 3 states 310, 320, 340, and 350).

A signal set S may include: device integrity and attestation freshness signals; binding consistency signals; epoch and time consistency signals; challenge and callback context binding signals; network and environment stability signals; interaction-continuity summaries; AOA presence and near-field consistency signals; document and artifact authenticity signals; relationship and institution evidence signals for recovery and adjudication planning; and token and revocation state signals.

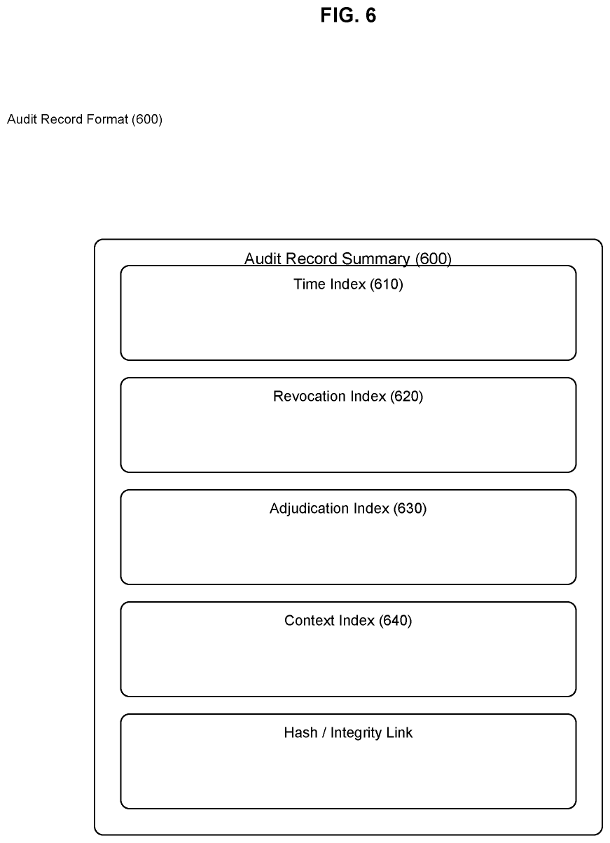

Signals may be boolean, categorical, or numeric. In privacy-preserving embodiments, audit record module (160) stores cryptographic summaries and indices (FIG. 6) rather than raw identity data.

A WICA-style fusion rule may compute a consistency score C and or a risk score R by normalizing signals and applying weighted combination, optionally including hard gates such that a failed context binding dominates.

Using DEA-style adaptation, policy engine (130) may adapt thresholds and escalation parameters to minimize expected burden while maintaining security, including thresholds for drift classification, step-up triggers, rollback window parameters, and adjudication thresholds.

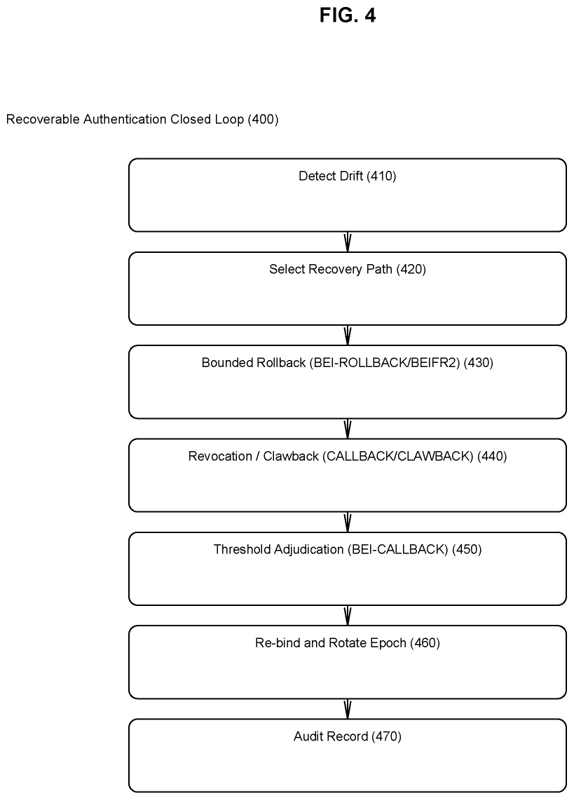

Normal path (FIG. 3 state 310) is selected when consistency is high and risk is low. Stepped-up path (FIG. 3 state 320) is selected when risk increases or consistency decreases but drift is not indicated. Drift detection (FIG. 3 state 340) is entered when drift indicators are satisfied. Recovery mode (FIG. 3 state 350) is entered when drift is classified and a recovery path is selected (FIG. 4 Step 420).

TABLE 2
lists non-limiting examples of risk and consistency
signals used by policy engine (130).

| Signal | Description |
|---|---|
| 1 | Device integrity and attestation freshness |
| | (secure execution environment (112) proof |
| | validity and freshness). |
| 2 | Binding consistency (request key identifier |
| | matches server-side binding state). |
| 3 | Epoch and time consistency (epoch match, |
| | time bucket consistency). |
| 4 | Challenge and callback context binding |
| | (challenge bound to CTX and nonce). |
| 5 | Network and environment stability (non- |
| | limiting network context changes). |
| 6 | Interaction-continuity summaries |
| | (cryptographic summaries without sensory |
| | CAPTCHA). |
| 7 | AOA presence and near-field consistency |
| | (optional). |
| 8 | Document and artifact authenticity via (170) |
| | and or (180) (optional). |
| 9 | Relationship and institution evidence for |
| | recovery and adjudication planning (optional). |
| 10 | Token and revocation state (revocation |
| | boundaries, epoch rotation boundaries). |

In Step 230 (Challenge Generation), challenge service (132) issues a challenge bound to scenario context and epoch.

### Time-Hierarchy Keys and Time-Bound Binding (Hour/Day/Week/Year)

In some embodiments, the system employs time-hierarchy keys at granularities HOUR, DAY, WEEK, and YEAR to bind proofs and tokens to time windows and policy epochs. The terminal device (110) stores root key material within secure execution environment (112) and does not expose it externally. Canonical indices may be derived for time buckets with permitted tolerance for clock skew.

Non-limiting key derivation examples include:

$$K\_year = KDF ( K\_root , “ YEAR ” ‖ T\_year ‖ E\_current )$$

$$K\_week = KDF ( K\_year , “ WEEK ” ‖ T\_week ‖ E\_current )$$

$$K\_day = KDF ( K\_week , “ DAY ” ‖ T\_day ‖ E\_current )$$

$$K\_hour = KDF ( K\_day , “ HOUR ” ‖ T\_hour ‖ E\_current )$$

where E_current is the policy epoch. The proof binds to challenge CH, context CTX, nonce N, epoch, and a selected time index. For example: DeviceProof=Sign_device(Hash(CH∥CTX∥N∥E_current∥T_g)) or a time-bound MAC using K_g.

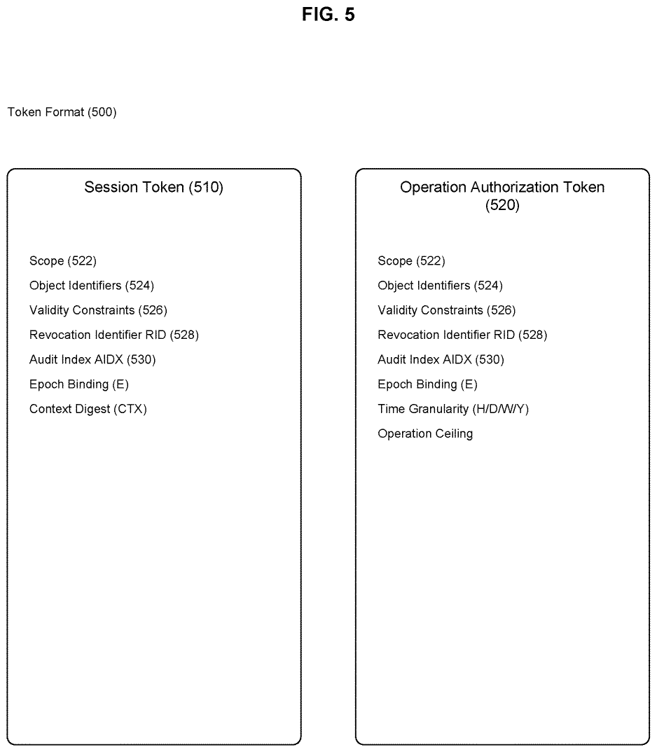

Policy engine (130) selects time granularity based on risk and consistency and state machine routing (FIG. 3). Normal authentication may require HOUR or DAY binding. Stepped-up may require WEEK or YEAR and or additional evidence. High-value operations may require stricter granularity and validity constraints. Tokens may encode the required granularity, allowed time window, and epoch binding (FIG. 5).

After bounded rollback, epoch rotation to E_new changes derived keys because epoch is included in derivation, preventing reuse of old proofs. Audit record module (160) stores summaries indicating selected granularity, time index family, and epoch identifier (FIG. 6) without storing secret material.

In Step 240 (Device Proof Generation), terminal device (110) uses device key (114) in secure execution environment (112) to sign the challenge and produce a device proof.

In Step 250 (BEISIGN Assertion), BEISIGN proof service (134) generates a BEISIGN privacy proof assertion that minimally discloses that the subject satisfies control, eligibility, or authorization conditions; optionally SIGN-SIGNED may be used.

In Step 260 (Verification), verifier (136) verifies the device proof and BEISIGN assertion.

In Step 270 (Token Issuance), on success, a session token or an operation authorization token is issued (FIG. 5) bound to scope, context, validity, revocation identifiers, audit indices, and epoch.

In Step 280 (Audit Summary), audit record module (160) stores cryptographic summaries and indices (FIG. 6).

### State Machine Behavior

FIG. 3 illustrates state machine (300). Normal Authentication (310) is a low-friction path, typically single terminal unlock leading to device proof plus BEISIGN verification. Stepped-up Authentication (320) is selected when policy engine (130) detects higher risk or reduced consistency; this may require stricter time granularity, presence evidence, or additional confirmation. Denial and Hold (330) occurs when policy constraints fail or attack is suspected; this optionally includes safe recovery entry. Drift Detection (340) is triggered on repeated failures, epoch mismatch, binding mismatch, or callback and context anomalies. Recovery Mode (350) involves bounded rollback plus adjudicated re-binding and revocation. Re-binding and Epoch Rotation (360) ensures old bindings and tokens are invalidated and a new baseline is established. Completion (370) restores a consistent baseline.

### State Transition Conditions (Table 1)

TABLE 1
describes non-limiting examples of state
transitions for state machine (300).

| Transition | Condition |
|---|---|
| 310 -> 320 | Increased authentication level due to risk or |
| | reduced consistency. |
| 310 -> 370 | Device proof and BEISIGN verification |
| | succeed; token issued. |
| 320 -> 370 | Step-up requirements succeed. |
| 310 or 320 -> 340 | Repeated failures exceed threshold, or epoch |
| | or binding mismatch, or callback or context |
| | anomaly. |
| 340 -> 350 | Failure classified as key state drift or binding |
| | inconsistency rather than ordinary entry error. |
| 350 -> 360 | Recovery path succeeds and rollback and |
| | rebinding are authorized. |
| 360 -> 370 | New binding established, epoch rotated, prior |
| | tokens clawed back, new tokens issued. |
| Any -> 330 | Fraud indicators or policy constraints fail; |
| | safe recovery entry may still exist. |

### Drift Classification and Recovery Trigger Logic

In some embodiments, policy engine (130) classifies failures into ordinary failure (step-up), suspected attack and hold, or key state drift and binding inconsistency requiring recovery. Inputs include signature verification result, binding match or mismatch, epoch match or mismatch, context binding pass or fail, failure count in window, fused scores, revocation boundary presence, and optional evidence.

An illustrative, non-limiting pseudocode for drift classification and routing includes:

Algorithm DriftClassifyAndRoute(request):

```
  V_sig := verify_device_proof(request)
  V_ctx := verify_context_binding(request)
  V_bind := binding_key_matches(request)
  V_epoch := epoch_matches(request)
  (C, R) := fuse_signals(request)
  if V_sig == PASS and V_ctx == PASS and V_bind == MATCH and V_epoch == MATCH
then
    issue_token_and_audit( ); transition_to(COMPLETION_370); return
  end if
  DriftIndicator := (V_ctx == FAIL) OR V_epoch == MISMATCH) OR
        (V_bind == MISMATCH AND V_sig == PASS) OR
        (FailCount exceeds threshold) OR
        (RevBoundary exists AND request appears bound to prior epoch)
  if DriftIndicator == TRUE then
    transition_to(DRIFT_DETECTION_340)
    if (C above drift-consistency floor) AND (R below attack-risk ceiling) then
      transition_to(RECOVERY_MODE_350)
      select_recovery_path( ); execute_recovery_closed_loop( )
    else
      transition_to(DENIAL_HOLD_330)
    end if
    write_audit_summary( ); return
  end if
  transition_to(STEP_UP_320 or DENIAL_HOLD_330); write_audit_summary( ); return
```

This classification treats key state drift as a governable technical condition and routes into an engineered recovery closed loop rather than requiring repeated sensory challenges or indefinite retry attempts.

### Recoverable Authorization Closed Loop

FIG. 4 illustrates process (400). Step 410 (Detect Drift) involves detecting key state drift based on authentication failure, callback anomaly, binding mismatch, epoch mismatch, or failed consistency validation. Step 420 (Select Recovery Path) involves selecting among trusted backup device confirmation, offline recovery package, or BEI-CALLBACK threshold adjudication.

In some embodiments, a recovery path uses an Offline Recovery Package (ORP) enabling recovery when drift prevents normal authentication. ORP provisioning at enrollment-time may include generating a recovery secret RS, computing a commitment stored server-side, and constructing an ORP payload with identifier references, policy hints, and nonce seeds, protected by encryption under secure execution environment material. During recovery-time ORP presentation, the terminal derives a candidate RS and generates an ORP proof bound to the recovery context, and the server validates the ORP proof prior to bounded rollback, epoch rotation, and clawback under policy. In higher-risk conditions, ORP validation may be used as an input to BEI-CALLBACK adjudication.

In some embodiments, BEI-CALLBACK threshold adjudication is executed by adjudication node set (150) to approve controlled re-binding after drift. Participants may include device nodes, institution nodes, and relationship nodes. A Rebinding Request Object (RRO) may be constructed including context, old and new bindings, epoch identifiers, and nonce. Partial approvals are generated by nodes and combined into an Adjudication Certificate (AC). Upon valid AC, recovery proceeds with bounded rollback where applicable, mandatory epoch rotation, clawback of prior tokens, binding update to a new binding, and issuance of new tokens bound to a new epoch.

Step 430 (Bounded Rollback) involves performing bounded rollback to a prior consistent checkpoint where applicable. Rollback controller (140) performs bounded rollback constrained by policy to restore a previously consistent binding state upon drift. The system maintains checkpoints with timestamps, binding digests, epoch identifiers, and audit indices. Rollback eligibility is constrained by time windows, attempt limits, consistency floors, and anti-replay requirements. Execution may include selecting a checkpoint, verifying integrity, restoring binding state, placing state into restricted recovery execution, triggering epoch rotation, and writing an audit entry.

Step 440 (Revocation and Clawback) executes CALLBACK and CLAWBACK to revoke prior bindings and invalidate prior tokens. Step 450 (Threshold Adjudication) optionally requires BEI-CALLBACK adjudication to approve re-binding. Step 460 (Re-bind and Rotate Epoch) binds new device key or credential and rotates epoch to enforce freshness boundaries. Step 470 (Audit Record) stores recovery evidence summaries including adjudication results, rollback records, and revocation records (FIG. 6).

### Token Structures

FIG. 5 illustrates token format (500). Session token (510) authorizes ordinary access. Operation authorization token (520) authorizes high-value operations. Tokens may include scope (522), object identifiers (524), validity constraints (526), revocation identifiers (528), audit indices (530), epoch binding, and time-granularity constraints.

Each token includes a revocation identifier RID and an audit index AIDX. A relying service validates token integrity, validity constraints, and revocation status by checking whether RID is revoked. Clawback execution includes adding RID to a revocation state keyed by epoch and/or checkpoint and recording the event. Epoch-coupled revocation ensures tokens bound to epochs at or before a boundary are invalidated upon epoch rotation, supporting deterministic invalidation after bounded rollback and recovery. In some embodiments, the operation authorization token is clawback-enabled by including an epoch-bound revocation identifier and a revocation boundary reference, thereby enabling deterministic invalidation across relying services upon bounded rollback, epoch rotation, dispute handling, or other policy-defined revocation events.

### Audit Record Structures

FIG. 6 illustrates audit record format (600), which may store only cryptographic summaries. Indices may include time indices (610), revocation indices (620), adjudication indices (630), and context indices (640). Audit record module (160) stores summaries of authentication decisions, drift classification, recovery operations, token issuance and clawback, and optional document verifications without storing raw secrets or unnecessary raw identity data.

### Document-Based Authentication Embodiment

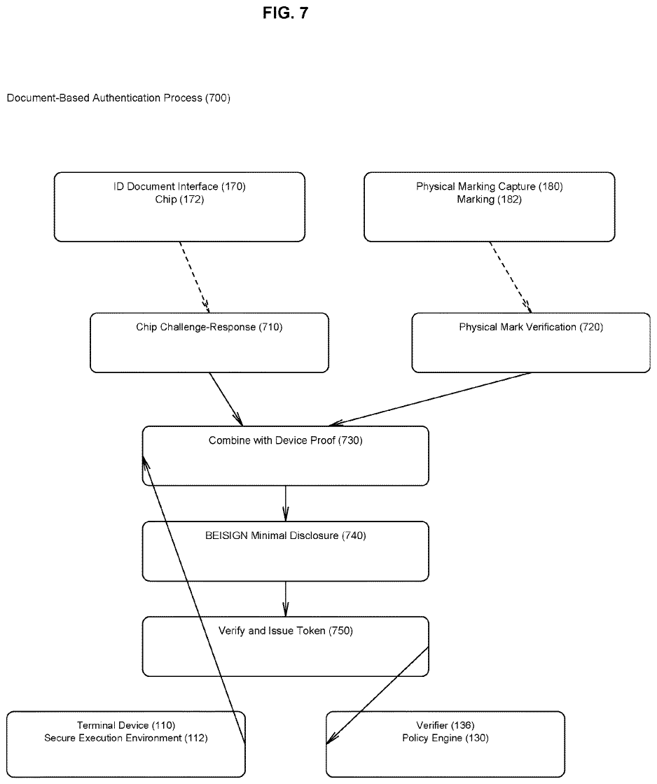

FIG. 7 illustrates process (700) combining an ID document chip (172) and or physical marking (182). Chip challenge-response may provide a chip proof. Physical marking verification may capture a physically unclonable signature and compute a verifiable summary. The terminal device (110) generates a device proof, and BEISIGN provides minimal disclosure. Verifier (136) verifies proofs, issues a token, and audit record module (160) records cryptographic summaries.

### Cross-Industry High-Value Authorization and Clearing

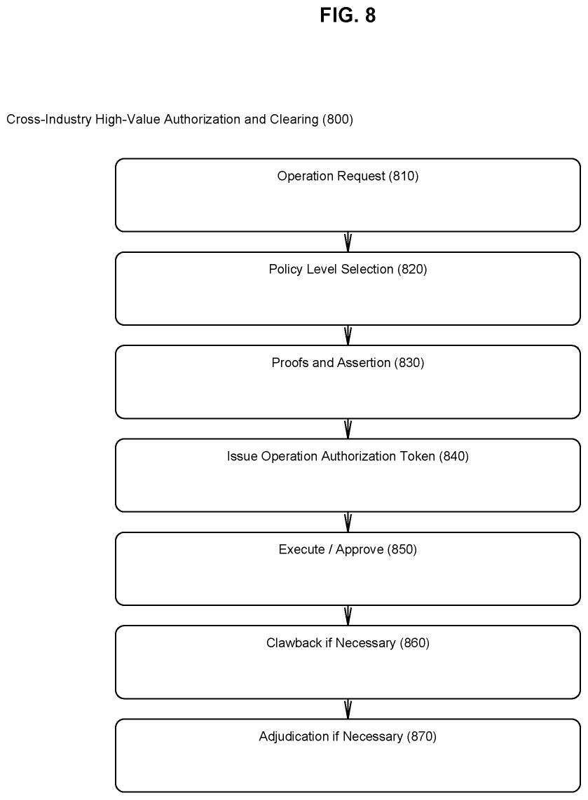

FIG. 8 illustrates process (800). Step 810 receives a transfer, exchange, clearing approval, contract signing, or privileged change request with context and object identifiers. Step 820 selects authentication level based on operation value, counterparty risk, and consistency signals.

Step 830 generates device proof, time-hierarchy binding, and BEISIGN assertion. Step 840 issues an operation authorization token including scope, object identifiers, constraints, revocation identifiers, audit indices, and epoch and time-granularity binding. Step 850 executes or approves the operation. Step 860 executes clawback on anomaly or dispute. Step 870 optionally executes BEI-CALLBACK adjudication for dispute resolution.

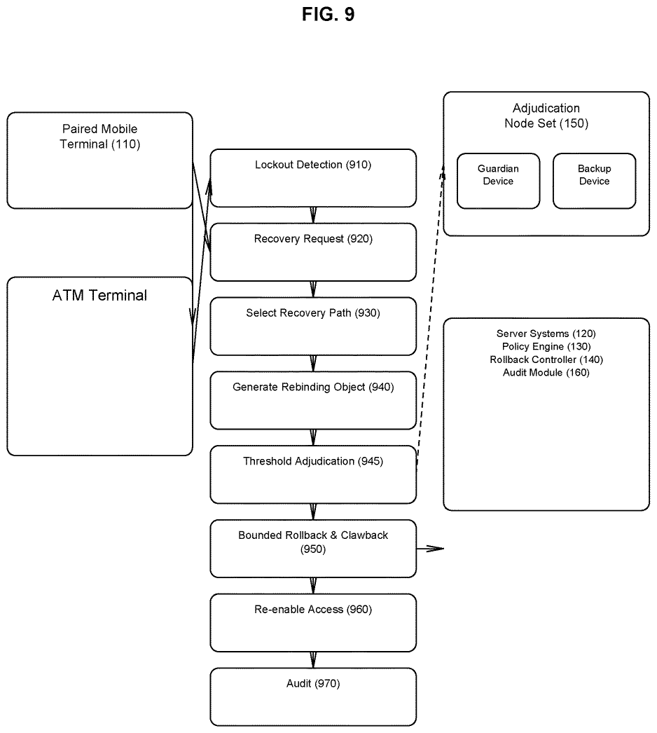

Atm Self-Service Recovery with Bei-Callback Threshold Adjudication (FIG. 9)

FIG. 9 illustrates process (900) enabling self-recovery at an automated teller machine (ATM) when a card is swallowed or account access is locked due to forgotten PIN or a risk trigger. In Step 910 (Lockout Detection), an ATM detects a swallow event or access denial due to PIN mismatch or a fraud or risk signal (for example, geofence breach or unusual amount). Instead of a permanent hold, the system exposes a recovery prompt to initiate self-recovery via trusted confirmation under policy control.

In Step 920 (Recovery Request), a subject activates recovery from a paired mobile terminal (110) that connects to the ATM via a near-field link such as NFC or a displayed link such as a QR code. The request may include RID_atm (a session revocation identifier), Bold (a current binding state), and CTX_atm (ATM context such as terminal identifier, time, and an amount ceiling).

In Step 930 (Select Recovery Path), policy engine (130) selects a BEI-CALLBACK path with pre-enrolled guardians in an m-of-n threshold policy (for example, 2-of-3 such as spouse, sibling, and backup device). Threshold nodes may include a subject mobile device with secure execution environment (112), one or more trusted contact devices fused via a relationship node, and an ATM-side secure enclave as an optional hardware signer.

In Step 940 (Generate Rebinding Object), the paired terminal constructs a Rebinding Request Object RRO_atm bound to CTX_atm, B_old, a new state B_new (for example, a new PIN, an ephemeral PIN, or a constrained recovery credential), and a new epoch E_new. In Step 945 (Threshold Adjudication), adjudication node set (150) collects partial signatures and, upon satisfaction of the threshold, outputs an adjudication certificate AC_atm computed as a combination of partial approvals over a digest of RRO_atm.

In Step 950 (Bounded Rollback and Clawback), rollback controller (140) executes BEI-ROLLBACK to a last consistent checkpoint (for example, last successful withdrawal), invalidates B_old and any open tokens via CLAWBACK, rotates to E_new, and provides a recovery outcome such as a release of the card or issuance of a one-time recovery PIN valid for a short window.

In Step 960 (Re-enable Access), the ATM accepts the new state and re-enables access under constraints. Non-limiting examples include immediate access to a limited operation (for example, withdraw only up to a pre-risk threshold), where the permission is bound to AC_atm and a validity window. In Step 970 (Audit), audit record module (160) logs a digest of AC_atm, a revocation index for RID_atm, a time index, and an ATM and geographic context binding, enabling post-event dispute clawback and evidence within a short response time.

In a non-limiting example deployment, self-service recovery converts a substantial portion of card swallow and lockout events from high-cost branch or call-center visits into zero-touch self-service flows, reducing operational cost while preserving audit chain and fraud control.

### Optional Variations

Secure execution environment (112) may be a TPM, secure enclave, secure element, trusted execution environment, or equivalent. Threshold adjudication may be m-of-n or weighted threshold signatures. Physical marking (182) may be any physically unclonable structure producing a stable verifiable summary. Audit records may store hash-only summaries rather than raw identity data. Time bucket tolerances may be used to reduce false rejection due to clock skew. Step-up policies may require additional evidence based on AOA, DEA, and WICA fusion outputs.

### Insert I—Technical Improvement Evidence and Structural Coupling

In some embodiments, the disclosed architecture provides measurable technical improvement in authentication reliability and recovery integrity relative to legacy MFA and sensory CAPTCHA-based workflows. In a non-limiting example evaluation using standardized authentication evaluation vectors consistent with NIST SP 800-63B guidance and simulated high-noise network conditions, the disclosed policy-driven state machine reduces false rejection relative to baseline MFA flows by routing drift-aware failures into recovery paths and by using fused consistency gating instead of sensory challenges.

In the non-limiting evaluation, reduction in false rejection is achieved primarily through fused consistency gating and drift-aware routing. Instead of escalating to visual or audio CAPTCHA challenges upon repeated failures, the system routes to stepped-up authentication when fused signals indicate elevated risk without drift, and routes to recovery mode when drift is classified with policy confidence, thereby reducing lockout loops caused by repeated challenge failures.

In some embodiments, bounded rollback and mandatory post-rollback epoch rotation provide a deterministic freshness boundary that prevents reuse of proofs or tokens across checkpoints, thereby mitigating replay within the bounded rollback window. Epoch-coupled revocation and clawback provide deterministic invalidation of prior authorizations upon anomaly, dispute, or recovery event.

In some embodiments, audit record module (160) stores cryptographic summaries and indices (FIG. 6) such that revocation and clawback decisions propagate across relying services with low latency. For high-value clearing and authorization systems (FIG. 8), the unified operation authorization token and epoch-bound revocation identifiers enable deterministic invalidation of prior authorizations without requiring raw identity disclosure to each relying service.

These improvements are structurally embedded. In representative implementations, secure execution environment isolation, epoch-coupled time-hierarchy binding, drift classification logic, bounded rollback, clawback, and BEI-CALLBACK threshold adjudication form a closed-loop unit. Removing any one element materially degrades the ability to detect drift, perform bounded rollback safely, or execute cross-domain clawback with auditable evidence.

### Additional High-Value Embodiments for Cross-Domain Deployment

In some embodiments, operation authorization token (520) is used in high-value payment, settlement, or clearing workflows, including central bank digital currency approval flows and interbank settlement. In some embodiments, the token is bound to an ISO 20022 message context such that object identifiers encode or reference ISO 20022 message identifiers, participant identifiers, and settlement instructions, and such that clawback invalidation is enforceable prior to final settlement under policy constraints.

In some embodiments, BEI-CALLBACK adjudication nodes include heterogeneous social or community evidence nodes for recovery and dispute resolution. Non-limiting examples include namespace-control proofs, community role attestations, and group membership proofs.

Policy engine (130) may assign weights to node types and require weighted threshold satisfaction such that no single social signal is sufficient while still enabling practical recovery and dispute closure.

In some embodiments, the AOA module provides a zero-trust office or facility access embodiment. For example, policy engine (130) may require an AOA-based spatial constraint indicating that a terminal device is within a defined proximity threshold of a trusted enterprise artifact, secure beacon, or facility reader prior to enabling device unlock, privileged administrative change, or high-value operation authorization.

The listed domain names are exemplary and non-limiting, and the disclosed domain-fabric mechanisms may be implemented using other domain names, namespaces, identifiers, or equivalent addressing schemes.

### Threat Model and Failure Modes

This disclosure provides technical improvements in identity-continuity authentication and recoverable authorization. In some embodiments, the disclosed system is engineered to address and close the loop on technical problems including: (i) key-state drift, in which server-side binding state diverges from terminal device key state; (ii) replay, including reuse of stale proofs, challenges, or tokens; (iii) unbinding and binding substitution, including unauthorized removal or replacement of binding material; (iv) false rejection loops, in which legitimate users are repeatedly denied due to noise, migration, clock skew, or policy feedback escalation; and (v) revocable auditability, in which verifiable evidence remains available while enabling controlled revocation and clawback.

In some embodiments, threat actors include a remote attacker attempting replay, phishing, token theft, or session hijacking; a local attacker attempting device theft, tampering, or bypass of a secure execution environment; an insider attacker attempting unauthorized privileged changes; and a collusive adversary attempting to exploit recovery and adjudication paths to seize control. In representative implementations, the system assumes standard cryptographic hardness of primitives and isolation of a secure execution environment at deployment, and further assumes that adjudication participants are pre-enrolled under policy with defined constraints.

In some embodiments, failure modes addressed include, without limitation: (i) drift and binding inconsistency, including mismatches among registered public keys, policy epoch, callback context bindings, and revocation boundaries; (ii) replay attempts that reuse stale device proofs, stale BEISIGN assertions, stale challenges, or stale tokens, including attempts to exploit rollback windows or epoch transitions; (iii) unauthorized unbinding or binding substitution, including replacement of device keys, recovery factor sets, callback endpoints, or policy bindings; (iv) false rejection loops caused by unstable networks, clock skew, device migration, or escalation feedback; and (v) lack of revocable auditability in legacy systems that cannot produce verifiable, minimally-disclosing audit evidence supporting deterministic invalidation across relying services.

In some embodiments, drift is treated as a distinct technical state rather than ordinary entry error. Drift indicators include, without limitation, an epoch mismatch, a binding mismatch, a callback or scenario context mismatch, or repeated failures within a policy window while a device proof remains otherwise valid. Upon drift classification, the identity-continuity state machine transitions into a controlled recovery mode that executes bounded rollback to a prior consistent checkpoint when permitted, mandatory epoch rotation to create a freshness boundary that structurally prevents reuse of prior derived materials, revocation and clawback of prior tokens and/or bindings, and threshold adjudication (BEI-CALLBACK) for controlled re-binding under scope and validity constraints.

In some embodiments, replay resistance is enforced by binding proofs and tokens to a cryptographic challenge and nonce, a scenario context digest, an epoch identifier, and a selected time-bucket granularity (e.g., HOUR, DAY, WEEK, YEAR) with an allowed tolerance window.

After rollback, epoch rotation causes derived keys and authorization material to become invalid across epochs. In some embodiments, false rejection is reduced by policy-driven signal fusion and adaptive thresholds that route legitimate drift-like failures into a bounded, auditable recovery path rather than an indefinite retry loop.

In some embodiments, revocable auditability is provided by storing cryptographic summaries and indices plus revocation handles, enabling later invalidation of authorizations and evidentiary linkage among authentication, drift detection, recovery actions, and re-binding events, without requiring disclosure of unnecessary raw identity data.

### Minimal Data Structures (Implementable Field Sets)

In some embodiments, a BEISIGN privacy proof assertion is represented using a minimal field set sufficient for verification, request binding, and revocation while avoiding unnecessary disclosure. A non-limiting minimal field set comprises: (i) assertion_id, an identifier of the assertion instance; (ii) subject commitment, a commitment or pseudonymous handle for the subject enabling policy-controlled correlation without exposing raw identity; (iii) issuer_or_context_id, an identifier of an issuer, prover context, relying domain, and/or schema; (iv) predicate_set, one or more predicates proven by the assertion, optionally expressed as a policy identifier plus parameters; (v) disclosed fields (optional), explicitly permitted disclosed attributes, with other attributes omitted; (vi) epoch id, an epoch binding for freshness and rollback safety; (vii) time_bucket, a time granularity identifier and index value used for bounded validity and replay resistance; (viii) ctx_digest, a digest binding the assertion to at least a challenge, nonce, and scenario context; (ix) revocation_handle, an identifier enabling later revocation of the assertion and/or an underlying credential; (x) proof_blob, a verifiable proof object (including a signature and/or a zero-knowledge proof) sufficient to validate predicate_set without outputting raw identity data; and (xi) validity window, not-before and not-after bounds (or equivalent) limiting assertion reuse.

In some embodiments, bounded rollback uses checkpoint records that permit deterministic restore under policy constraints and prevent replay across rollback boundaries. A non-limiting minimal field set for a checkpoint record comprises: (i) checkpoint id, an identifier for the checkpoint; (ii) checkpoint_time, a timestamp and/or time-bucket index used for rollback eligibility evaluation; (iii) epoch id, an epoch identifier associated with the checkpoint; (iv) binding_digest, a cryptographic digest of binding state at the checkpoint including at least registered key material digests and binding metadata digests; (v) revocation_boundary_id, an identifier of a revocation boundary or revocation set used for deterministic clawback at or after rollback; (vi) integrity link, a hash-chain, Merkle reference, or equivalent integrity linkage for audit integrity; (vii) policy_window_id, an identifier encoding rollback constraints including at least a time window and at least one of attempt limits, risk ceilings, geographic constraints, or device-class constraints; (viii) context_summary_digest, a digest of relevant context summaries without storing raw personal data; (ix) audit index, an index or pointer linking to audit entries associated with checkpoint creation and later restoration; and (x) restore_params (optional), minimal restore parameters or references sufficient to reconstruct a consistent state under restricted execution without exposing secrets.

In some embodiments, threshold adjudication produces an adjudication certificate that authorizes a constrained re-binding and supports later verification and revocation. A non-limiting minimal field set comprises: (i) ac_id, an identifier of the adjudication certificate; (ii) rro_digest, a digest of a rebinding request object that binds old state, new state, constraints, epoch, and scenario context; (iii) threshold_rule, an identifier and parameters of a threshold policy including m-of-n and/or weighted threshold; (iv) participant_set_summary, a summary of participant types and optional weights including at least two of device nodes, institution nodes, or relationship nodes, without storing unnecessary raw identity data; (v) partial_signature_set and/or references thereto; (vi) combined_signature, an aggregated threshold signature or equivalent aggregate proof over rro_digest; (vii) validity_window, time bounds limiting certificate reuse; (viii) scope_constraints, explicit constraints authorized by the certificate including at least one of operation ceilings, permitted scopes, device-class constraints, or geographic constraints; (ix) revocation_handle, an identifier enabling later revocation of the certificate; (x) audit index, an index or pointer linking to audit entries for the adjudication event; and (xi) ctx_digest (optional), a digest binding the adjudication certificate to a specific scenario context.

The foregoing minimal field sets illustrate implementable structures sufficient for interoperable encoding, verification, request binding, bounded validity, replay resistance, revocation and clawback, and auditable linkage among authentication decisions, drift classification, recovery actions, and re-binding decisions. In some embodiments, the fields are encoded as structured objects, records, or messages and are processed by verifier logic, rollback controller logic, adjudication node logic, and audit record logic as described herein, and implementations may add fields, omit optional fields, or vary field names while preserving cryptographic verifiability, scenario-context binding, epoch binding, and revocation capability.

### APPENDIX TO SPECIFICATION

An appendix to this specification, entitled “APPENDIX TO SPECIFICATION—RELATED BEI×BEI GALAXY×ATMS×DOMAIN-BASED ECOSYSTEM FILINGS,” may be submitted herewith. The appendix provides a consolidated list of approximately three hundred eighty (380) related U.S. and international patent applications filed by the present inventor and commonly owned entities, and is incorporated herein by reference for technical background and ecosystem context, to the extent not inconsistent with the present disclosure. The applications listed in the appendix may have various prosecution statuses, including pending, allowed, issued, or abandoned.

In addition, in some embodiments, a further appendix may be prepared, entitled “APPENDIX—DOMAIN-NAME PORTFOLIO FOR BEI×BEI GALAXY×ATMS ECOSYSTEM.” Such an appendix, if filed in connection with this application or a related application, may set forth a portfolio list of approximately two thousand eight hundred (2,800) unique, system-level domain names associated with the BEI, BEI Galaxy, ATMS, and related ecosystems. These domain names are described herein as ecosystem components that can function as namespaces and routing endpoints for BEI identities and YueNames, digital land parcels and service nodes within a multi-layer domain fabric, and anchors for material, resource, and asset flows represented in time-ledger and tokenization mechanisms described in this specification. To the extent any such domain-name appendix is filed in connection with this application, it is incorporated herein by reference for technical background and ecosystem context, to the extent not inconsistent with the present disclosure.

Except where an individual application is expressly identified in this Cross-Reference to Related Applications section and/or in the ADS as a priority application or domestic benefit application, the applications, publications, domain names, and materials listed in any appendix are not relied upon for priority, domestic benefit, or foreign priority in the present application. Identification of such applications, publications, or domain names in any appendix is not an admission that any such document or material constitutes prior art to the present application. The appendix is provided for technical background only and is not essential under 35 U.S.C. § 112.

1. A method of identity-continuity authentication and recoverable authorization, comprising: receiving, by a server, an access request or an operation request associated with a subject identifier, a scenario context, and a request type; determining, by a server-side policy engine, an authentication level from fused risk signals and consistency signals; selecting, by an identity-continuity authentication state machine, an authentication path corresponding to the authentication level; generating a cryptographic challenge bound to at least the scenario context and an epoch; generating, by a terminal device using a device key protected in a secure execution environment, a device proof by signing the cryptographic challenge; generating a BEISIGN privacy proof assertion that minimally discloses that the subject satisfies a control, eligibility, or authorization condition without outputting raw identity data; verifying the device proof and the BEISIGN privacy proof assertion; upon successful verification, issuing a session token or an operation authorization token including at least one revocation identifier and at least one audit index; detecting key state drift or binding inconsistency based on at least one of an epoch mismatch, a binding mismatch, a callback anomaly, or failed consistency validation; and upon detection of the key state drift or binding inconsistency, automatically transitioning the state machine into a recovery mode and executing a recovery closed loop comprising performing bounded rollback to a prior consistent checkpoint, rotating to a new epoch, revoking or clawing back at least one prior binding or token, performing threshold adjudication using BEI-CALLBACK to approve re-binding, re-binding to a new binding state, and writing a non-repudiable audit summary linking the authentication, drift detection, recovery, revocation, and re-binding.

2. An identity-continuity authentication and recoverable authorization system, comprising: a terminal device comprising a secure execution environment storing a device key and configured to generate a device proof bound to a cryptographic challenge; a server-side policy engine configured to compute fused risk and consistency signals, select an authentication level, and execute an identity-continuity authentication state machine; a verifier configured to verify the device proof and a BEISIGN privacy proof assertion and to issue a session token or an operation authorization token bound to an epoch and including a revocation identifier and an audit index; a rollback controller configured to detect key state drift or binding inconsistency, perform bounded rollback to a prior consistent checkpoint, and trigger epoch rotation; an adjudication node set configured to perform BEI-CALLBACK threshold adjudication and output a verifiable adjudication result for controlled re-binding; and an audit record module configured to store cryptographic summaries and indices associated with authentication decisions, rollback, revocation and clawback, adjudication, and re-binding events.

3. A method for self-service recovery at an automated terminal, comprising: detecting, by the automated terminal, an access lockout event or a card capture event due to a credential failure or a risk signal; presenting a self-recovery option via a paired mobile terminal; constructing a rebinding request object bound to a terminal context, a current binding state, and a new binding state; submitting the rebinding request object to an adjudication node set for BEI-CALLBACK threshold approval using m-of-n partial signatures from heterogeneous nodes including at least one trusted contact device; upon satisfaction of the threshold approval, performing bounded rollback to a prior consistent checkpoint, clawback invalidating the current binding state and at least one open token, and rotating to a new epoch; re-enabling terminal access with a time-bound permission using the adjudicated result; and writing a non-repudiable audit summary linking the terminal event, the adjudication, and the revocation.

4. The method of claim 1, wherein the authentication path employs a time-hierarchical key system comprising HOUR, DAY, WEEK, and YEAR granularities, and wherein a selected granularity is determined by the authentication level.

5. The method of claim 1, wherein the policy engine computes at least one consistency score and at least one risk score using multi-signal fusion and adaptively selects a stepped-up authentication path when risk increases without drift.

6. The method of claim 1, wherein the authentication path avoids sensory CAPTCHA challenges and instead uses at least the device proof and an interaction-continuity cryptographic summary.

7. The method of claim 1, wherein the operation authorization token is configured for at least one of resource access control, asset transfer, exchange, clearing approval, contract signing, or privileged administrative change, and includes scope, object identifiers, validity constraints, the revocation identifier, and the audit index.

8. The method of claim 1, wherein detecting key state drift comprises classifying a verification failure as drift when an epoch mismatch or binding mismatch is detected while the device proof remains valid.

9. The method of claim 1, wherein bounded rollback is constrained by at least one of a time window, an attempt limit, a policy threshold, or a device and geographic consistency condition.

10. The method of claim 1, wherein rotating to the new epoch changes derived time-hierarchy keys and invalidates reuse of proofs across checkpoints.

11. The method of claim 1, wherein BEI-CALLBACK threshold adjudication uses an m-of-n threshold signature or a weighted threshold signature and includes at least two node types selected from device nodes, institution nodes, and relationship nodes.

12. The method of claim 1, further comprising using an offline recovery package provisioned at enrollment-time as an input to the recovery closed loop.

13. The method of claim 1, further comprising verifying at least one of an identification document chip challenge-response proof or a physically unclonable physical marking summary in combination with the device proof and the BEISIGN privacy proof assertion.

14. The system of claim 2, wherein the audit record module stores at least two indices selected from a time index, a revocation index, an adjudication index, and a context index to support cross-domain auditing and dispute evidence.

15. The system of claim 2, wherein the adjudication node set comprises heterogeneous nodes including at least one institution node and at least one relationship node configured to provide verifiable evidence based on a predefined relationship context.

16. The system of claim 2, wherein the policy engine uses at least one of AOA, DEA, or WICA logic to adapt thresholds for drift classification, rollback windows, and adjudication parameters.

17. The method of claim 3, wherein the m-of-n threshold requires at least two-of-three signatures including a subject backup device and at least one pre-enrolled guardian device.

18. The method of claim 3, wherein bounded rollback is constrained to events within a policy-defined time window not exceeding one hour, and wherein clawback applies to active session tokens derived from a prior epoch.

19. The method of claim 3, wherein post-recovery access is limited to an operation ceiling determined by a fused risk score prior to full re-authentication.

20. The method of claim 3, wherein the paired mobile terminal connects to the automated terminal via NFC or a QR link and the terminal context includes a geographic binding.
